(19) United States
(12) Patent Application Publication
(10) Pub. No.: US 2003/0080852 A1
(43) Pub. Date: May 1, 2003

(54) Secure smart card

(75) Inventor: Richard H. Harris, Raleigh, NC (US)

Correspondence Address: SAWYER LAW GROUP, P.O. Box 51418, Palo Alto, CA, 94303, US

(73) Assignee: International Business Machines Corporation, Armonk, NY

(21) Appl. No.: 10/002,752

(22) Filed: Oct. 31, 2001

(51) Int. Cl. H04B 1/00; G05B 19/00

(52) U.S. Cl. 340/5.54; 340/5.61

(57) ABSTRACT

A method for providing a secure transaction includes: receiving a new identification verification data by a transaction device directly from a user; storing the new identification verification data on the transaction device only, where the new identification verification data is not shared with another device; receiving an input of an identification verification data by the transaction device directly from the user; activating the transaction device for a predetermined period of time if the inputted identification verification data matches the new identification verification data; and deactivating the transaction device when an event occurs. The event can be the expiration of a predetermined period of time, the completion of the secure transaction, or some other event. No additional devices are needed to input or store the new identification verification data on the smart card. In this manner, if the transaction device is lost or stolen, it is useless to anyone not knowing the new identification verification data.

### FIELD OF THE INVENTION

The present invention relates to secure transactions, and more particularly, to secure transactions which require user identification verification.

### BACKGROUND OF THE INVENTION

The security requirements for commercial transactions, such as in merchant/consumer transactions, are well known in the art. For example, security measures may be taken for the use of a credit card. One conventional security measure is to assign the user authorized to use the credit card an identification verification data, such as a personal identification number (PIN). The PIN is typically sent to the user separately from the credit card. The user first presents the credit card to a merchant for a transaction. The user then is required to enter the PIN into a PIN capturing device to complete the transaction. However, the PIN capturing device results in a cost for equipment, counter space, and maintenance for the merchant. Additional time is required to capture the PIN to complete the transaction. In addition, when the user changes the PIN, the new PIN typically is a shared secret with another device. For example, the user's new PIN is stored by a larger system, which places the new PIN onto the credit card. Another device may be required to verify the PIN during a transaction. The sharing of the PIN increases the security risks and costs of the system.

Accordingly, what is needed is an improved method and system for providing a secure transaction. The improved method and system should eliminate the need for additional equipment, maintenance, and counter space for the merchant. It should also eliminate the need to share the identification verification data with another device. The present invention addresses such a need.

### SUMMARY OF THE INVENTION

A method for providing a secure transaction includes: receiving a new identification verification data by a transaction device directly from a user; storing the new identification verification data on the transaction device only, where the new identification verification data is not shared with another device; receiving an input of an identification verification data by the transaction device directly from the user; activating the transaction device if the inputted identification verification data matches the new identification verification data; and deactivating the transaction device when an event occurs. The event can be either the expiration of a predetermined period of time or the completion of the secure transaction. No additional devices are needed to input or store the new identification verification data on the transaction device. In this manner, if the transaction device is lost or stolen, it is useless to anyone not knowing the new identification verification data.

### DESCRIPTION OF THE DRAWINGS

FIG. 1 is a flowchart illustrating a preferred embodiment of a method for providing a secure transaction in accordance with the present invention.

FIG. 2 illustrates a preferred embodiment of a transaction device in accordance with the present invention.

FIG. 3 is a flowchart illustrating in more detail the method for providing a secure transaction in accordance with the present invention.

### DETAILED DESCRIPTION

The present invention relates to an improved method and system for providing a secure transaction. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The method and system in accordance with the present invention comprises a transaction device which facilitates secure transactions. The user may enter a new identification verification data directly into the transaction device. This new identification verification data is stored on the transaction device only, without sharing the data with another device. The user activates the transaction device by inputting the new identification verification data directly into the transaction device. The transaction device remains active until a specific event occurs, such as the expiration of a predetermined period of time or the completion of a secure transaction.

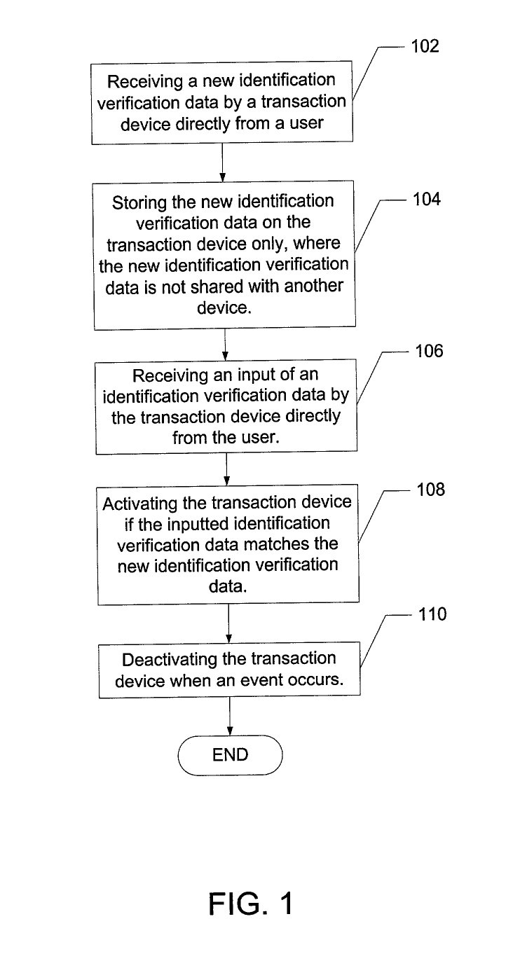

To more particularly describe the features of the present invention, please refer to FIGS. 1 through 3 in conjunction with the discussion below.

FIG. 1 is a flowchart illustrating a preferred embodiment of a method for providing a secure transaction in accordance with the present invention. First, the transaction device receives a new identification verification data directly from the user, via step 102. In the preferred embodiment, an initial identification verification data, such as a Personal Identification Number (PIN), is assigned to the authorized user. The user can then change the identification verification data directly into the transaction device without the assistance of additional devices. The new identification verification data is then stored on the transaction device only, via step 104, where the identification verification data is not shared with another device.

When the user wishes to complete a secure transaction, the user inputs an identification verification data. The transaction device receives the input of the identification verification data directly from the user, via step 106. The transaction device then verifies the inputted identification verification data by determining if the inputted identification verification data matches the new identification verification data stored on the transaction device. If the inputted identification verification data matches the new identification verification data, the transaction device is activated, via step 108. The transaction device is deactivated when an event occurs, via step 110. In the preferred embodiment, the event can be the expiration of a predetermined period of time, the completion of the secure transaction, or some other event.

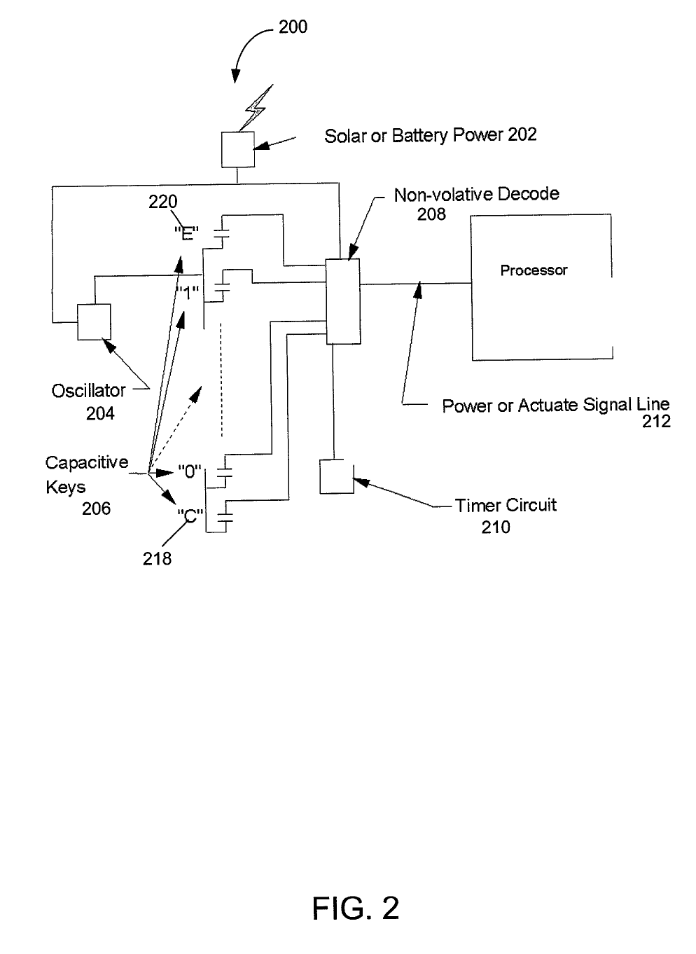

FIG. 2 illustrates a preferred embodiment of a transaction device in accordance with the present invention. The transaction device 200 comprises a power source 202, such as a solar or battery power source. The power source 202 is coupled to an oscillator 204, which is coupled to a plurality of capacitive keys 206. The capacitive keys 206 reside under surface keys (not shown) on the transaction device 200. Each of the capacitive keys 206 comprises two sides. The first side is coupled to the oscillator 204, which provides AC pulses to the first side of each of the capacitive keys 206. The second side is coupled to a non-volative decode 208. While the first and second sides are decoupled, the oscillator 204 provides a low capacitance between the two sides. When the first and second sides are coupled, the capacitance between the two sides is increased. This increased capacitance is sensed, decoded, and stored by the non-volative decode 208. The timer circuit 210 coupled to the non-volative decode 208 controls the amount of time in which the transaction device 200 is active. The non-volative decode 208 is coupled to a processor 214. The non-volative decode 208 may assert or de-assert an activation signal to the processor 214 via a power or actuate signal line 212. The processor 214 performs the transaction device functions. Signals are output from the transaction 200 through connectors (not shown).

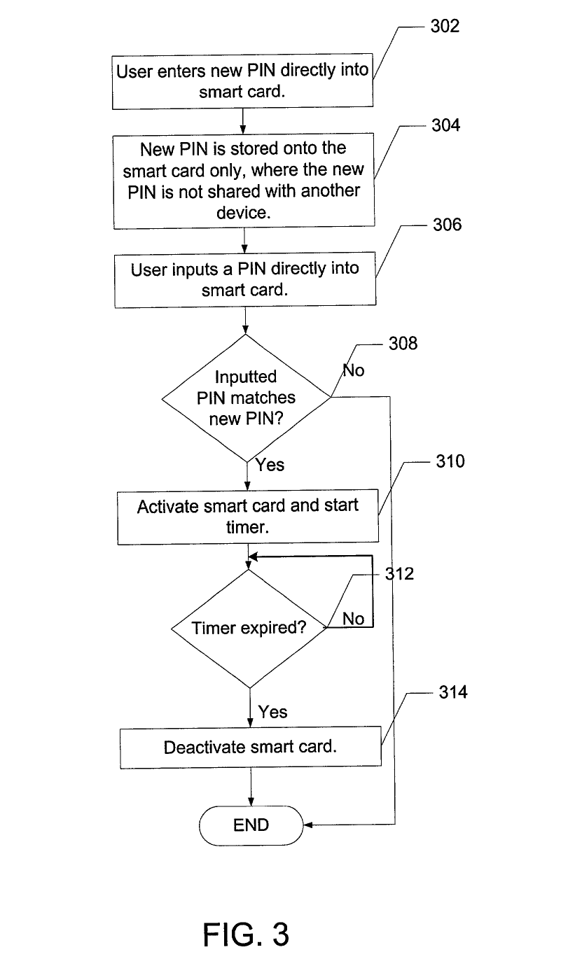

FIG. 3 is a flowchart illustrating in more detail the method for providing a secure transaction in accordance with the present invention. Assume that the identification verification data is a PIN initially assigned to the authorized user and that the transaction device 200 is a smart card. First, the user enters a new PIN directly into the smart card 200, via step 302. In the preferred embodiment, the user first presses the “C” key 218 on the smart card 200 to clear any inadvertent entries. The user inputs the initial PIN. Then the user presses the “E” key 220 on the smart card 200 to indicate the input of a new PIN. The user then enters the new PIN by pressing the surface keys.

The pressing on the surface keys couples the first and second sides of the respective capacitive keys 206 under the surface keys, increases the capacitance of these capacitive keys 206. The non-volative decode 208 senses and decodes the increased capacitances and stores the new PIN, via step 304, without sharing the new PIN with another device. No additional devices are needed to input or store the new PIN. Nor is the new PIN required to be shared with another device in order to facilitate a secure transaction.

In the preferred embodiment, prior to tendering the smart card 200 for the purpose of completing a secure transaction, the user first presses the “C” key 218 to clear any inadvertent input via the surface keys. The user then inputs a PIN directly into the smart card 200 utilizing the surface keys, via step 306. The pressing on the surface keys increases the capacitance of the respective capacitive keys 206. The non-volative decode 208 senses and decodes the increased capacitances and stores the inputted PIN. The non-volative decode 208 next verifies the inputted PIN by comparing the inputted PIN with the stored new PIN, via step 308. If they do not match, then the smart card 200 is not activated. If they do match, then the smart card 200 is activated and a timer is started, via step 310. The smart card 200 is activated when the non-volative decode 208 asserts an activation signal to the processor 214 via the power or actuate signal line 212. Approximately at the same time, the timer circuit 210 is initiated. The timer circuit 210 expires after a predetermined period of time. During this period of time, the user and the merchant may complete the secure transaction by interfacing with the smart card 200 via the connectors (not shown). When the timer circuit 210 expires, via step 312, the smart card 200 is deactivated, via step 314. Alternatively, the smart card 200 may be deactivated when the present secure transaction is completed. The smart card 200 is deactivated by the non-volative decode 208 de-asserting the activation signal to the processor 214. If the smart card 200 is deactivated before the transaction can be completed, the user must reenter the PIN in order to reactivate the smart card 200.

Although the present invention is described above in the context of a PIN, one of ordinary skill in the art will understand that other biometric identification data may be used without departing from the spirit and scope of the present invention. For example, a fingerprint or signature may be used.

Although the present invention is described above with surface keys and capacitive keys, one of ordinary skill in the art will understand that other types of interfaces for communicating the identification verification data may be used without departing from the spirit and scope of the present invention.

Although the transaction device is described above as a smart card, one of ordinary skill in the art will understand that any type of transaction devices which can facilitate a secure transaction may be used without departing from the spirit and scope of the present invention.

An improved method and system for providing a secure transaction has been disclosed. The present invention comprises a transaction device into which a user may directly enter a new identification verification data. No additional devices are needed. This new secure user identifying information is stored on the transaction device only, without sharing the data with another device. The user activates the transaction device by inputting an identification verification data into the transaction device. The transaction device activates itself if the inputted identification verification data matches the new identification verification data stored in the transaction device. The transaction device remains activated until an event occurs. The event can be the expiration of a predetermined period of time, the completion of a secure transaction, or some other event. In this manner, if the transaction device is lost or stolen, it is useless to anyone not knowing the new identification verification data. A secure transaction is provided without merchants having to purchase or maintain an identification verification data capture device, lowering the cost of the system. The transaction time is reduced because the identification verification data is inputted before the transaction device is tendered instead of afterwards. Also, the institution issuing the transaction device does not have to maintain and manage the identification verification data.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing a secure transaction, comprising the steps of:
(a) receiving a new identification verification data by a transaction device directly from a user;
(b) storing the new identification verification data on the transaction device only, wherein the new identification verification data is not shared with another device;
(c) receiving an input of an identification verification data by the transaction device directly from the user;
(d) activating the transaction device if the inputted identification verification data matches the new identification verification data; and
(e) deactivating the transaction device when an event occurs.

2. The method of claim 1, wherein the receiving step (a) comprises:
(a1) assigning an initial identification verification data to the user;
(a2) receiving the initial identification verification data by the transaction device directly from the user;
(a3) verifying the initial identification verification data by the transaction device;
(a4) receiving an indication of a new identification verification data by the transaction device; and
(a5) receiving the new identification verification data by the transaction device directly from the user.

3. The method of claim 1, wherein the activating step (d) comprises:
(d1) determining if the inputted identification verification data matches the new identification verification data by the transaction device;
(d2) activating the transaction device if the inputted identification verification data matches the new identification verification data; and
(d3) starting a timer if the transaction device is activated, wherein the timer expires after the predetermined period of time.

4. The method of claim 3, wherein the deactivating step (e) comprises:
(e1) deactivating the transaction device when the timer expires.

5. The method of claim 1, wherein the deactivating step (e) comprises:
(e1) deactivating the transaction device when the secure transaction is completed.

6. The method of claim 1, wherein the new identification verification data comprises at least one of the following:
a personal identification number;
a fingerprint; or
a signature.

7. A method for providing a secure transaction, comprising the steps of:
(a) receiving an initial identification verification data by the transaction device directly from the user;
(b) verifying the initial identification verification data by the transaction device;
(c) receiving a new identification verification data by the transaction device directly from the user;
(d) storing the new identification verification data on the transaction device only, wherein the new identification verification data is not shared with another device;
(e) receiving an input of an identification verification data by the transaction device directly from the user;
(f) determining if the inputted identification verification data matches the new identification verification data by the transaction device;
(g) activating the transaction device if the inputted identification verification data matches the new identification verification data;
(h) starting a timer if the transaction device is activated, wherein the timer expires after a predetermined period of time; and
(i) deactivating the transaction device when the timer expires.

8. A method for providing a secure transaction, comprising the steps of:
(a) receiving an initial identification verification data by the transaction device directly from the user;
(b) verifying the initial identification verification data by the transaction device;
(c) receiving a new identification verification data by the transaction device directly from the user;
(d) storing the new identification verification data on the transaction device only, wherein the new identification verification data is not shared with another device;
(e) receiving an input of an identification verification data by the transaction device directly from the user;
(f) determining if the inputted identification verification data matches the new identification verification data by the transaction device;
(g) activating the transaction device if the inputted identification verification data matches the new identification verification data; and
(h) deactivating the transaction device when the secure transaction is completed.

9. A transaction device, comprising:
an inputting means for receiving an inputted identification verification data;
a decoder coupled to the inputting means for sensing, decoding, and verifying the inputted identification verification data; and
a processor coupled to the decoder, wherein the decoder asserts an activation signal to the processor if the identification verification data is verified, wherein the decoder de-asserts the activation signal when an event occurs.

10. The device of claim 9, wherein the event comprises a completion of a secure transaction.

11. The device of claim 9, further comprising:
a timer circuit coupled to the decoder, wherein the timer circuit is initiated when the decoder asserts the activation signal, wherein the timer circuit expires after a predetermined period of time, wherein the event comprises the expiration of the timer circuit, wherein the decoder de-asserts the activation signal to the processor when the timer circuit expires.

12. The device of claim 9, wherein the inputting means comprises a plurality of capacitive keys, wherein each capacitive key comprises a first side and a second side.

13. The device of claim 9, further comprising:
an oscillator coupled to the inputting means; and
a power source coupled to the oscillator and the decoder.

14. The device of claim 9, wherein the decoder comprises a stored identification verification data, wherein the decoder verifies the inputted identification verification data by determing that the inputted identification verification data matches the stored identification verification data.

15. A transaction device, comprising:
a plurality of capacitive keys for inputting an identification verification data, wherein each capacitive key comprises a first side and a second side;
an oscillator coupled to the first side of each capacitive key;
a decoder coupled to the second side of each capacitive key for sensing, decoding, and verifying the inputted identification verification data when the first and second sides of at least one of the capacitive keys are coupled, wherein the decoder comprises a stored identification verification data, wherein the decoder verifies the inputted identification verification data by determining that the inputted identification verification data matches the stored identification verification data;
a power source coupled to the oscillator and the decoder;
a processor coupled to the decoder, wherein the decoder asserts an activation signal to the processor if the inputted identification verification data is verified; and
a timer circuit coupled to the decoder, wherein the timer circuit is initiated when the decoder asserts the activation signal, wherein the timer circuit expires after a predetermined period of time, wherein the decoder de-asserts the activation signal to the processor when the timer circuit expires.

16. A transaction device, comprising:
a plurality of capacitive keys for inputting an identification verification data, wherein each capacitive key comprises a first side and a second side;
an oscillator coupled to the first side of each capacitive key;
a decoder coupled to the second side of each capacitive key for sensing, decoding, and verifying the inputted identification verification data when the first and second sides of at least one of the capacitive keys are coupled, wherein the decoder comprises a stored identification verification data, wherein the decoder verifies the inputted identification verification data by determining that the inputted identification verification data matches the stored identification verification data;
a power source coupled to the oscillator and the decoder; and
a processor coupled to the decoder, wherein the decoder asserts an activation signal to the processor if the inputted identification verification data is verified, wherein the decoder de-asserts the activation signal to the process when a secure transaction is completed.
